(19) United States
(12) Patent Application Publication
(10) Pub. No.: US 2024/0246556 A1
(43) Pub. Date: Jul. 25, 2024

(54) METHOD, SYSTEM AND COMPUTER PROGRAM PRODUCT FOR AUTONOMOUSLY OR SEMI-AUTONOMOUSLY OPERATING A MOTOR VEHICLE

(71) Applicant: Dr. Ing. h.c. F. Porsche Aktiengesellschaft, Stuttgart (DE)

(72) Inventor: Moritz Markofsky, Bruchsal (DE)

(21) Appl. No.: 18/415,917

(22) Filed: Jan. 18, 2024

(30) Foreign Application Priority Data
Jan. 23, 2023 (DE) 10 2023 101 537.0

(51) Int. Cl. B60W 50/14; B60W 50/06; B60W 50/10; G07C 5/02

(52) U.S. Cl. CPC B60W 50/14; B60W 50/06; B60W 50/10; G07C 5/02; B60W 2050/146

(57) ABSTRACT

A method is provided for autonomously or semi-autonomously operating a motor vehicle using a DAS (driving assistance system) that is operated in real terms with a first hardware version and/or software version (20). Real operating data (12) are recorded during operation of the DAS with the first hardware version and/or software version and also are recorded during operation of the motor vehicle by the driver with or without assistance from the DAS. The DAS is operated virtually in a shadow mode (9) with at least a second hardware version and/or software version. Virtual operating data are determined during operation of the DAS with the second hardware version and/or software version. Real operating data (12) are compared with virtual operating data, and the result of the comparison is used to make the driver aware of the advantages of switching from the first (20) to the second hardware version and/or software version.

### CROSS-REFERENCE TO RELATED APPLICATION

This application claims priority on German Patent Application No. 10 2023 101 537.0 filed Jan. 23, 2023, the entire disclosure of which is incorporated herein by reference.

### BACKGROUND

### Field of the Invention

The invention relates to a method and system for autonomously or semi-autonomously operating a motor vehicle using a driving assistance system that is operated in real terms with a first hardware version and/or software version. Real operating data of the motor vehicle are recorded during operation of the driving assistance system with the first hardware version and/or software version. Real operating data of the motor vehicle also are recorded during operation of the motor vehicle by the driver with or without assistance from the driving assistance system.

### Related Art

DE 10 2021 003 073 B3 discloses a method for increasing the proportion of automated driving in a semi-automated driving vehicle. The method and device determine how energy, traffic flow and safety balance of a manual drive that has taken place would have differed from a possible automated drive. The information obtained is used to estimate a recommendation for manual takeover by the driver.

DE 10 2022 002 085 A1 discloses a method and system for adapting a combined data collection and software update campaign in a vehicle fleet, in which data determined by a vehicle are sent to an evaluation unit outside of the vehicle and further processed in this unit. The evaluation unit outside of the vehicle selects a plurality of vehicles of the vehicle fleet with regard to vehicle characteristics and their geographical locations. The evaluation unit then permanently analyzes a speed and an amount of data sent by the selected vehicles to the evaluation unit with regard to predetermined end criteria of the combined data collection and software update campaign, and dynamically varies the number of vehicles of the vehicle fleet involved in the data collection and software update campaign as a function thereof.

US 2022/0342804 A1 discloses a test system for a motor vehicle having an autonomous driving function, wherein information for the autonomous driving function is collected in a so-called shadow mode in the background.

DE 10 2021 000 595 A1 discloses a method for validating an assistance function of a driving assistance system of a motor vehicle. A control unit of the driving assistance system is designed, such that a development status of the software is operated in parallel to a series status of the software in a so-called shadow mode, and new assistance functions and updates of certain software are thereby tested in the field.

DE 10 2020 130 748 A1 discloses a method and system for generating a virtual environment of a motor vehicle. The virtual environment is used for development, safeguarding and/or training of motor vehicles and/or systems of motor vehicles.

U.S. Pat. No. 11,531,349 B2 discloses a method for detecting and storing information describing errors in a predictive path planning function of a neural network.

DE 10 2021 110 812 A1 discloses a method and system for developing, training, and/or operating a motor vehicle system.

The object of the invention is to simplify and/or improve autonomous or semi-autonomous operation of a motor vehicle.

### SUMMARY OF THE INVENTION

The invention relates to a method for autonomously or semi-autonomously operating a motor vehicle using a driving assistance system that is operated in real terms with a first version of hardware and/or software. Real operating data of the motor vehicle are recorded during operation of the driving assistance system with the first version of the hardware and/or software. Real operating data of the motor vehicle also are recorded during operation of the motor vehicle by the driver with or without assistance from the driving assistance system, such that the driving assistance system is operated virtually in a shadow mode with at least a second version of the hardware and/or software. Virtual operating data of the motor vehicle are determined during operation of the driving assistance system with the second version of the hardware and/or software. The real operating data of the motor vehicle in the driving mode are compared with the virtual operating data of the motor vehicle. The result of the comparison is used to make the driver aware of the advantages of switching from the first to the second version of the hardware and/or software. The second hardware version and/or software version of the driving assistance system may comprise specific, additional or improved functions that are not yet enabled by the driver or an owner of the vehicle. The second version of the hardware and/or software is operated and tested in the background in the so-called shadow mode, while in real driving mode, data is collected about any potential of the second version of the hardware and/or software for the individual user of the motor vehicle. Based on this collected data, the individual user can be offered particularly advantageous specific functions of the second version of the hardware and/or software. The second or a further version of the hardware and/or software then can be enabled for the user on request, i.e., on-demand.

In some embodiments of the method, the same input data are supplied to the driving assistance system during operation with the first and second versions of the hardware and/or software. Thus, it can be determined objectively whether switching from the first to the second version of the hardware and/or software would provide significant advantages for the driver when operating the driving assistance system.

The input data of the driving assistance system may comprise sensor data, driver data, and/or partner control unit data. In this way, existing means can be used to test highly effectively in an open loop in shadow mode whether the second version of the hardware and/or software offers advantages for the individual driver.

The result of the comparison between the real operating data of the motor vehicle in driving mode and the virtual operating data of the motor vehicle may be displayed to the driver along with an offer to purchase the second version of the hardware and/or software. The comparison result may be displayed to the driver in the vehicle via a suitable display if there would be significant advantages for the driver when operating the driving assistance system with the second version of the hardware and/or software.

The second version of the hardware and/or software may comprise a freeway pilot that is tested in shadow mode. The freeway pilot, which has not yet been enabled, can be used to determine whether a certain freeway section that is frequently used by the driver could possibly be driven fully automatically in real-life operation of the motor vehicle. For example, the driver can be informed how much time he could use for secondary activities during automated driving of this freeway section that he would otherwise not be able to perform while driving.

In one embodiment, the second version of the hardware and/or software comprises a park assistant that is tested in shadow mode. For example, this exemplary embodiment offers advantages if the driver has to regularly park in a driveway in the evening under complicated conditions. The driving assistance system uses the park assistant operating in shadow mode to analyze whether the repetitive, complicated parking operation could be fully automated with the park assistant. If this is the case, the corresponding outcome would create an incentive for the driver to purchase.

In another embodiment, the second version of the hardware and/or software comprises a driverless parking garage service that is tested in shadow mode. This embodiment is advantageous if the driver regularly uses a parking garage that has a necessary sensor infrastructure for automated valet parking. In the shadow mode, it is easy to check whether the driverless parking garage service of the second version of the hardware and/or software is compatible with the sensor infrastructure of the parking garage. This compatibility would create a significant purchase incentive.

The second version of the hardware and/or software may comprise an enhanced emergency brake assistance that is tested in shadow mode. Here too, the comparison between the real emergency braking behavior of the driver and the emergency braking behavior of the enhanced emergency braking assistant could create a significant incentive for purchase with regard to a reduced accident risk.

Another aspect of the invention relates to a system for autonomous or semi-autonomous operation of a motor vehicle using a driving assistance system according to the method described above. The system may comprise an analysis module in which the real operating data of the motor vehicle in driving mode is compared with the virtual operating data of the motor vehicle. In this way, it is possible to find out by simple means during operation whether switching from the first to the second hardware version and/or software version could provide significant advantages for the driver of the motor vehicle.

The invention further relates to a computer program product on which a computer program code is stored. The computer program code can be executed on at least one computer, such that the at least one computer is caused to perform the method described above. The at least one computer may comprise an on-board computer of the motor vehicle and/or may be configured to communicate with a cloud.

Further advantages, features, and details of the invention arise from the following description, in which various exemplary embodiments of the invention are described in detail with reference to the drawings.

### BRIEF DESCRIPTION OF THE DRAWINGS

FIG. 1 schematically illustrates an electrical/electronic architecture with a control unit of an autonomously or semi-autonomously operable motor vehicle.

FIG. 2 schematically illustrates a software architecture having different versions that are operated and analyzed for testing purposes in a shadow mode.

### DETAILED DESCRIPTION

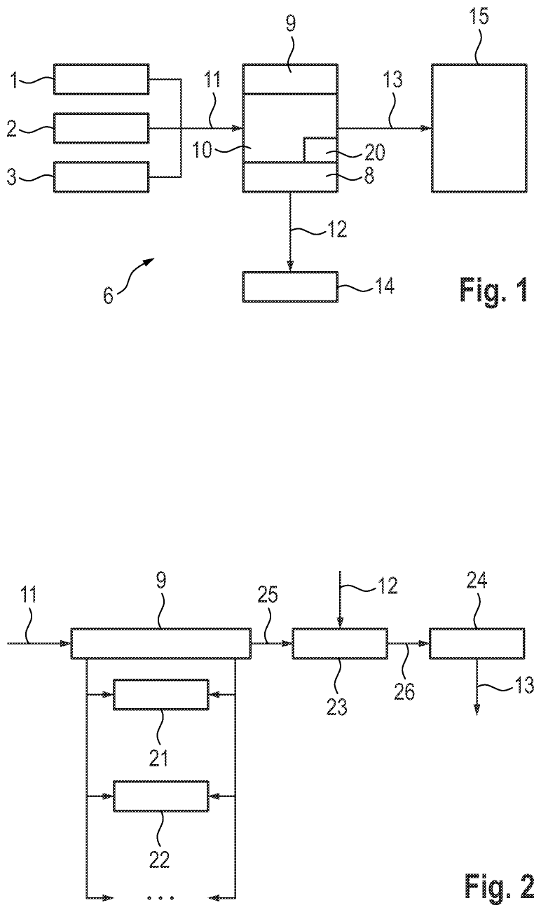

The electrical/electronic architecture that is illustrated schematically in FIG. 1 includes a control unit 100. The control unit 10 is, for example, an on-board computer of a motor vehicle that can be operated autonomously or semi-autonomously. The on-board computer 10 is used together with an actuator 14 to represent a driving assistance system 6 in the motor vehicle.

The actuator 14 can be used to drive the vehicle semi-autonomously or autonomously, in particular to accelerate, brake and/or steer. An arrow 12 indicates that the actuator 14 is controlled via the control unit 10 with a first software version in a real mode 8 with real operating data 12.

The rectangle 9 represents the shadow mode and indicates that the control unit 10 can also perform a shadow mode 9. In the shadow mode 9, a second software version, for example, for testing purposes, runs in the background without affecting the real operation of the motor vehicle.

Input data 11 are supplied to the control unit 10. The input data 11 can be processed in the control unit 10 in both real mode 8 and shadow mode 9. The input data 11 comprise sensor data provided by a sensor system 1 in or on the motor vehicle. The input data 11 further comprise driver data provided by a real driver 2 of the motor vehicle during operation.

The input data 11 of control unit 10 further comprise partner control unit data provided by partner control units 3. For example, the partner control units 3 originate from further motor vehicles of a vehicle fleet comprising a plurality of motor vehicles.

An arrow 13 in FIG. 1 indicates output data that are supplied to a display 15. On-request functions of the driving assistance system 6 can be offered to the driver via the display 15, i.e., on-demand. The display 15 can be used to show advantageous information that is of individual benefit to the respective driver.

The driving assistance system 6, comprises hardware components and software components. The hardware components and the software components can be in different versions.

It is possible and useful to install different versions of the hardware components in the motor vehicle, even if they are not initially purchased together with the motor vehicle. If necessary, hardware components that have not yet been purchased can be enabled or added if the owner or driver chooses to do so after the vehicle has been purchased. For example, some versions of hardware and/or software on electric vehicles or plug-in hybrids may enable faster charging times or longer driving ranges after a recharge. Other versions may provide additional options for a driver assistance system or more sophistication options.

Software components, in particular updates or additional versions of software components, can be downloaded automatically in the background during operation of the motor vehicle. A corresponding software update also is referred to as an over-the-air update. In the control unit 10, the input data 11 is processed with the aid of a current software version 20 and used to control the actuator 14 via the real operating data 12 with the aid of the current software version 20. The current software version 20 also is referred to as first software version 20.

In FIG. 2, a second software version 21 and a third software version 22 are indicated by rectangles below the rectangle illustrating the shadow mode 9 or a shadow mode environment of the on-board computer or control unit. The software versions 21, 22 can be tested in shadow mode 9. Three dots indicate that further software versions can be tested in shadow mode 9.

The arrow 11 in FIG. 2 indicates that the software versions 21, 22 are operated in shadow mode with the same input data 11 with which the current software version 20 is operated in the on-board computer 10 to control the actuator 14 with the real operating data 12.

The software versions 21, 22 represent second or further software versions. The input data 11 are processed with software versions 21, 22 in shadow mode 9 to generate virtual operating data 25. The virtual operating data 25 are compared to the real operating data 12 in an analysis module 23. The resulting analysis data 26 are fed to an output module 24. The output module 24 then is used to feed the output data 13 to the display, which is designated 15 in FIG. 1. The display 15 of some embodiments will give the operator of the vehicle an option to make a purchase so that the second and/or third versions 21, 22 of the software can be purchased via the display and installed as an over-the-air update so that the operator can begin getting the benefit of the update immediately or on the next re-start of the vehicle. Some updates consist of or include hardware. In these circumstances, the display may give the operator of the vehicle an opportunity to purchase the hardware and/or schedule a vehicle service for installing the hardware.

### REFERENCE NUMBERS

1 Sensor system
2 Driver
3 Partner control units
6 Driving assistance system
8 Real mode
9 Shadow mode
10 Control unit
11 Input data
12 Real operating data
13 Output data
14 Actuator
15 Display
20 Software version
21 Software version
22 Software version
23 Analysis module
24 Output module
25 Virtual operating data
26 Analysis data

1. A method for autonomously or semi-autonomously operating a motor vehicle using a driving assistance system (6) that is operated in real terms with a first version of hardware and/or software (20), the method comprising:
recording real operating data (12) of the motor vehicle during operation of the driving assistance system (6) with the first version of hardware and/or software (20);
recording real operating data (12) of the motor vehicle while operating the motor vehicle by the driver with or without assistance from the driving assistance system (6);
operating the driving assistance system (6) virtually in a shadow mode (9) with at least a second version of hardware and/or software (21);
determining virtual operating data (25) of the motor vehicle while operating the driving assistance system (6) with the second version of the hardware and/or software (21);
comparing the real operating data (12) of the motor vehicle in a driving mode with the virtual operating data (25) of the motor vehicle;
reporting the comparison to the driver and thereby making the driver aware of advantages of switching from the first version (20) of the hardware and/or software to the second (21) second version of the hardware and/or software.

2. The method of claim 1, wherein the same input data (11) is fed to the driving assistance system (6) during operation with the first version (20) and the second version (21) of the hardware and/or software.

3. The method of claim 1, wherein the input data (11) of the driving assistance system (6) comprise sensor data, driver data, and/or partner control unit data.

4. The method of claim 1, wherein reporting the comparison to the driver comprises displaying the comparison to the driver along with an offer to purchase the second version of the hardware and/or software (21).

5. The method of claim 4, wherein displaying the comparison to the driver comprises displaying the comparison on a display device (15) in the motor vehicle.

6. The method of claim 5, wherein the offer to purchase the second version of the hardware and/or software (21) is made via the display device (15) in the motor vehicle, and wherein the offer to purchase the second version of the hardware or software (21) is accepted by the operator of the motor vehicle via the display device (15).

7. The method of claim 6, further comprising installing the second version of the software (21) as an over-the-air update after the offer to purchase the second version of the hardware and/or software (21) is accepted by the operator of the motor vehicle.

8. The method of claim 6, further comprising scheduling a vehicle service via the display device (15) after the offer to purchase the second version of the hardware and/or software (21) is accepted by the operator of the motor vehicle.

9. The method of claim 1, wherein the second version of the hardware and/or software (21) comprises a freeway pilot that is tested in the shadow mode (9).

10. The method of claim 1, wherein the second version of the hardware and/or software (21) comprises a park assistant that is tested in the shadow mode (9).

11. The method of claim 1, wherein the second version of the hardware and/or software (21) comprises a driverless parking garage service tested in the shadow mode.

12. The method of claim 1, wherein the second version of the hardware and/or software (21) comprises an enhanced emergency braking assistant that is tested in the shadow mode (9).

13. A system for autonomous or semi-autonomous operation of a motor vehicle using a driving assistance system (6) according to the method of claim 1, the system comprising an analysis module (23) in which the real operating data (12) of the motor vehicle in driving mode is compared to the virtual operating data (25) of the motor vehicle.

14. A computer program product on which a computer program code is stored, wherein the computer program code can be executed on at least one computer, such that the at least one computer is caused to perform the method of claim 1, wherein at least one of the computers is an on-board computer (10) of the motor vehicle and/or is configured to communicate with a cloud.
